(19) United States
(12) Patent Application Publication
(10) Pub. No.: US 2013/0224398 A1
(43) Pub. Date: Aug. 29, 2013

(54) METHOD AND SYSTEM FOR PAINTING A PART OF A MOTOR VEHICLE BODY

(71) Applicant: Sophie Vidal, Villieu Loyes Mollon (FR)

(72) Inventor: Sophie Vidal, Villieu Loyes Mollon (FR)

(73) Assignee: COMPAGNIE PLASTIC OMNIUM, Lyon (FR)

(21) Appl. No.: 13/729,365

(22) PCT Filed: Jun. 29, 2011
(86) PCT No.: PCT/FR2011/051521

§ 371 Date: May 10, 2013

(30) Foreign Application Priority Data
Jun. 29, 2010 (FR) 1055231

(51) Int. Cl. B05B 15/12

(52) U.S. Cl. CPC B05B 15/1288
USPC 427/558; 427/372.2; 427/553; 118/58

(57) ABSTRACT

The invention relates in particular to a method of painting a motor vehicle bodywork part, the method comprising the steps consisting in applying a first component on the part, in allowing the first component to tension on said part during a so-called “flash-off” stage, then in applying a second component on the part, the part being moved by a handler robot in front of a stationary applicator during the two spraying steps and in front of flash-off acceleration means during the flash-off stage. The invention also provides a painting booth having at least one stationary applicator for applying a paint component on a part carried by an arm of a handler robot that is present in the booth, and means for accelerating the flash-off of the part, the means being arranged in the booth in such a manner that the part can enter into the field of action of the acceleration means while being carried by the same handler robot.

### FIELD OF THE INVENTION

The invention relates to the field of painting motor vehicle bodywork parts.

### BACKGROUND OF THE INVENTION

Motor vehicle parts are often painted in a painting production line that is in the form of an installation in which hangers carrying a plurality of parts for painting travel one after another through a succession of workstations. A painting line may also comprise workstations for performing the following actions in succession:
flaming;
applying a primer;
possibly stoving for drying if the primer uses water as its solvent (the primer is then said to be water-based, otherwise it is solvent-based);
applying a base;
possibly stoving once more for drying if the base is a water-based base;
applying varnish; and
heating for baking.

The substances referred to as “primer”, “base”, and “varnish”, are also referred to as “paint components”.

Transferring parts between two workstations takes the length of time needed for traveling the distance between the two workstations. Advantage can be taken of this time to allow paint components that have just been applied to spread in uniform manner over the surface of the part. The paint component may be said to be “tensioning”, and this results from balancing of the surface tensions in the applied layer of paint component while it is still liquid. Simultaneously, the solvent (water or otherwise) evaporates, thereby making the applied paint component less liquid and causing it to set, while conserving the tension in the layer. This combined stage of tensioning and of solvent evaporation is generally referred to as “flash-off”. It takes place immediately after each of the application stages (applying primer, base, and varnish) and before the following above-defined stage. Its duration may be adjusted depending on requirements by lengthening the path followed by the hangers between one application workstation and the next workstation.

With another paint component technology, e.g. a paint component that needs to be cured, solvent evaporation may be combined with a curing step. Under such circumstances, the paint component is exposed to radiation by an infrared or an ultraviolet system in order to cause the paint component in the layer to be subjected simultaneously to curing and to tensioning. The stage that consists in leaving the paint component to tension, while also curing it, corresponds to “flash-off”.

In the description below, the term “flash-off” is used generally for the operation to which the paint component is subjected immediately after it has been applied and before the above-defined next workstation. In the invention, “flash-off” is thus a combination of surface tensioning and either loss of solvent, or curing, or any other operation that has the effect of causing the tensioned paint component to set.

### Object and Summary of the Invention

The present invention relates in particular to booth type painting installations, which differ from painting lines by the fact that parts are taken thereto, not by hangers running through a succession of workstations, but by a handler robot that moves them in front of one or more stationary applicators in the painting booth. Since the applicator(s) is/are stationary, the delivery of the paint component for application and the control over the air streams within which the particles of paint are sprayed take place under conditions that are better and less expensive.

In these more-compact installations, a part may thus pass very quickly from a step of applying one component to the following step of applying the next component (e.g. from the step of spraying a primer to a step of spraying a base), without sufficient time remaining for the flash-off of the first layer.

Confronted with that problem, and by analogy with a painting line in which the path to be followed between two workstations is lengthened in order to obtain sufficient flash-off time, the most obvious solution consists in depositing the part in a waiting zone, or even in another booth nearby, so as to give it the time required for flash-off immediately after the first component has been applied, and then to cause the robot to process another part during the flash-off time (processing can then be said to be taking place in full or in part in concurrent operating time). Thus, occupation of the robot is maximized, which is often the best way of maximizing the return on such an expensive investment.

Nevertheless, the inventors have carried out tests on the handling of parts by the robot during flash-off time, and they have found that, contrary to received ideas, it is not necessarily most efficient to deposit a part in a waiting zone.

The invention also relates to painting lines in which the path to be followed between two successive paint component application workstations cannot be lengthened without leading to major drawbacks, in terms of space occupation.

Thus, the present invention provides a method of painting a motor vehicle bodywork part, the method comprising the steps consisting in applying a first component on the part and in allowing said first component to tension on said part during a so-called “flash-off” stage, wherein during at least the flash-off stage, the part is moved by a handler robot in front of flash-off acceleration means.

The invention thus amounts to using a robot during the flash-off time of the part to assist in accelerating flash-off.

In a preferred implementation, a second component is applied on the part after the flash-off step.

If a third component is to be applied, a new flash-off step may be provided between the second and third applications, or even after the third application.

The flash-off acceleration means may consist in a dry air generator, a hot air generator, a blower, or a combination of these, so as to lead to dehydration (loss of water) or desolvation (loss of solvent other than water), or a source of ultraviolet or infrared radiation to cure the paint component.

The flash-off acceleration means may also comprise an air blower that blows air onto the part at a speed greater than the speed at which air flows around the part during the application step.

The first paint component may be a primer or a base. The second paint component may be a base or a varnish.

In a particular implementation of the invention, the part is moved by the robot during the operation of the flash-off acceleration means so as to expose the entire painted surface of the part to said flash-off acceleration means. The robot thus contributes to reducing the duration of flash-off by optimizing the exposure of the part in front of the acceleration means, which means may then present a limited field of application. By using the robot, it is thus possible to make use of flash-off acceleration means that are highly localized, compact, inexpensive, and that consume little energy.

In another implementation of the invention, the flash-off acceleration means comprise a part support for interposing between an arm of the handler robot and the part, said support presenting surfaces that contact with non-painted portions of the part, these contact surfaces being provided with heater means.

In a particular implementation of the invention, the part is moved by the handler robot in front of an applicator for applying a paint component during at least one of the application steps. Under such circumstances, the invention applies to booth type painting installations in which a handler robot moves parts in front of one or more applicators.

With a painting line, the robot makes it possible to avoid any need to lengthen the path followed by parts between two workstations for applying paint components (e.g. between the primer and the base or between the base and the varnish). This may apply if a painting line that was originally designed for applying components based on a non-aqueous solvent is being transformed into a painting line for applying aqueous components, since the flash-off time between two successive workstations must then be lengthened.

Advantageously, the applicator is “stationary”, which may mean:
either that it is secured to a support and does not move at all;
or that it can move between two paint spraying steps, but that it remains stationary while spraying, its movement generally being restricted to pivoting in order to simplify the method of controlling it;
or else it is capable of pivoting during spraying to match its orientation with the direction in which the part is being swept, in such a manner that the paint “impact” (the name given to the zone struck by the flared “beam” being sprayed on the part) is adapted to the movement of the part relative to the applicator (for example it is often preferable for the long dimension of the paint impact to be perpendicular to the sweeping direction of the part).

In other words, even if the applicator has certain freedoms of movement, it is considered as being stationary in the meaning of the invention providing its movements are restricted to swiveling movements, in contrast to a movable applicator that is moved in front of a stationary part for painting in order to sweep paint over the entire part.

The invention also provides a painting installation, comprising:
at least one applicator for applying a paint component on a part;
a handler robot; and
flash-off acceleration means for accelerating the flash-off of the part and arranged in such a manner that the part can enter into the field of action of the acceleration means while being carried by the handler robot.

In an embodiment, the acceleration means are put into operation only while the arm of the handler robot is presenting the part in the field of action of said acceleration means.

In a particular embodiment of the invention, the painting installation comprises a booth and the handler robot is present in the booth, where it serves to present the part for painting in front of a paint applicator (preferably an applicator that is stationary in the above-defined meaning), before presenting it in front of the flash-off acceleration means.

### BRIEF DESCRIPTION OF THE DRAWINGS

In order to make the invention better understood, there follows a description of an implementation given by way of non-limiting example and with reference to the accompanying diagrammatic drawing, in which:

FIG. 1 is a perspective view of a painting booth; and

FIG. 2 is a view from beneath of the ceiling of the FIG. 1 booth.

### MORE DETAILED DESCRIPTION

In order to begin by explaining the advantage of the invention, it is appropriate to recall that it differs from a more conventional solution consisting in placing a freshly-painted part in a waiting zone to allow it a flash-off time between two applications of paint components.

However, leaving a part to perform its flash-off in a waiting zone implies firstly a significant increase in the tasks to be performed by the robot (e.g. placing a first part in the waiting zone, placing a second part in the waiting zone, taking back the first part, taking back the second part, etc.), and implies secondly investments and surface areas in installations that are reserved for this waiting zone (e.g.: a second booth fitted with stacking means, a ventilation system and a communicating airlock controlled together with the painting booth).

These observations are summarized in the comparative table below which lists the operations and the movements performed by the robot under two configurations in which three paint components are applied (primer, base, and varnish):
processing two parts in parallel with temporary storage of a part 1 for flash-off while application is taking place on the part 2, and vice versa; and
sequential processing of the two parts with application and flash-off for the part 1, and then application and flash-off for the part 2.

| | | |
|---|---|---|
| Parallel | Sequential | |
| Part 1 and part 2 | Part 1 | Part 2 |
| Go to stock | Go to stock | |
| Grip part 1 | Grip part 1 | |
| Take part 1 from | Take part 1 from | |
| stock to primer | stock to primer | |
| applicator | applicator | |
| Take part 1 from | Take part 1 from | |
| primer applicator | primer applicator | |
| to waiting zone | to flash-off | |
| | accelerator | |
| Deposit part 1 | | |
| Go empty to stock | | Go empty to stock |
| Grip part 2 | | Grip part 2 |
| Take part 2 from | | Take part 2 from |
| stock to primer | | stock to primer |
| applicator | | applicator |
| Take part 2 from | | Take part 2 from |
| primer applicator | | primer applicator |
| to waiting zone | | to flash-off |
| | | accelerator |
| Deposit part 2 | | |
| Go empty from | | |
| waiting zone to | | |
| waiting zone | | |
| Grip part 1 | | |
| Take part 1 from | Take part 1 from | |
| waiting zone to | flash-off | |
| base applicator | accelerator to | |
| | base applicator | |
| Take part 1 from | Take part 1 from | |
| base applicator to | base applicator to | |
| waiting zone | flash-off | |
| | accelerator | |
| Deposit part 1 | | |
| Go empty from | | |
| waiting zone to | | |
| waiting zone | | |
| Grip part 2 | | |
| Take part 2 from | | Take part 2 from |
| waiting zone to | | flash-off |
| base applicator | | accelerator to |
| | | base applicator |
| Take part 2 from | | Take part 2 from |
| base applicator to | | base applicator to |
| waiting zone | | flash-off |
| | | accelerator |
| Deposit part 2 | | |
| Go empty from | | |
| waiting zone to | | |
| waiting zone | | |
| Grip part 1 | | |
| Take part 1 from | Take part 1 from | |
| waiting zone to | flash-off | |
| varnish applicator | accelerator to | |
| | varnish applicator | |
| Take part 1 from | Take part 1 from | |
| varnish applicator | varnish applicator | |
| to waiting zone | to flash-off | |
| | accelerator | |
| Deposit part 1 | | |
| Go empty from | | |
| waiting zone to | | |
| waiting zone | | |
| Grip part 2 | | |
| Take part 2 from | | Take part 2 from |
| waiting zone to | | flash-off |
| varnish applicator | | accelerator to |
| | | varnish applicator |
| Take part 2 from | | Take part 2 from |
| varnish applicator | | varnish applicator |
| to waiting zone | | to flash-off |
| | | accelerator |
| Deposit part 2 | | |
| Go empty from | | |
| waiting zone to | | |
| waiting zone | | |
| Grip part 1 | | |
| Take part 1 from | Take part 1 from | |
| waiting zone to | flash-off | |
| outlet | accelerator to | |
| | outlet | |
| Deposit part 1 | Deposit part 1 | |
| Go empty from | | |
| waiting zone to | | |
| waiting zone | | |
| Grip part 2 | | |
| Take part 2 from | | Take part 2 from |
| waiting zone to | | flash-off |
| outlet | | accelerator to |
| | | outlet |
| Deposit part 2 | | Deposit part 2 |

The operations that are underlined are those that are performed in addition if the two parts are processed in parallel so as to allow each of them a flash-off time in a waiting zone, instead of processing them sequentially, as in the invention.

It can thus be seen that depositing the part in the waiting zone involves eighteen additional operations for the robot.

By means of the invention, not only are those eighteen additional operations avoided, but also flash-off time between two applications is shortened because of the fact that the robot arm is used to present the part in front of the flash-off accelerator.

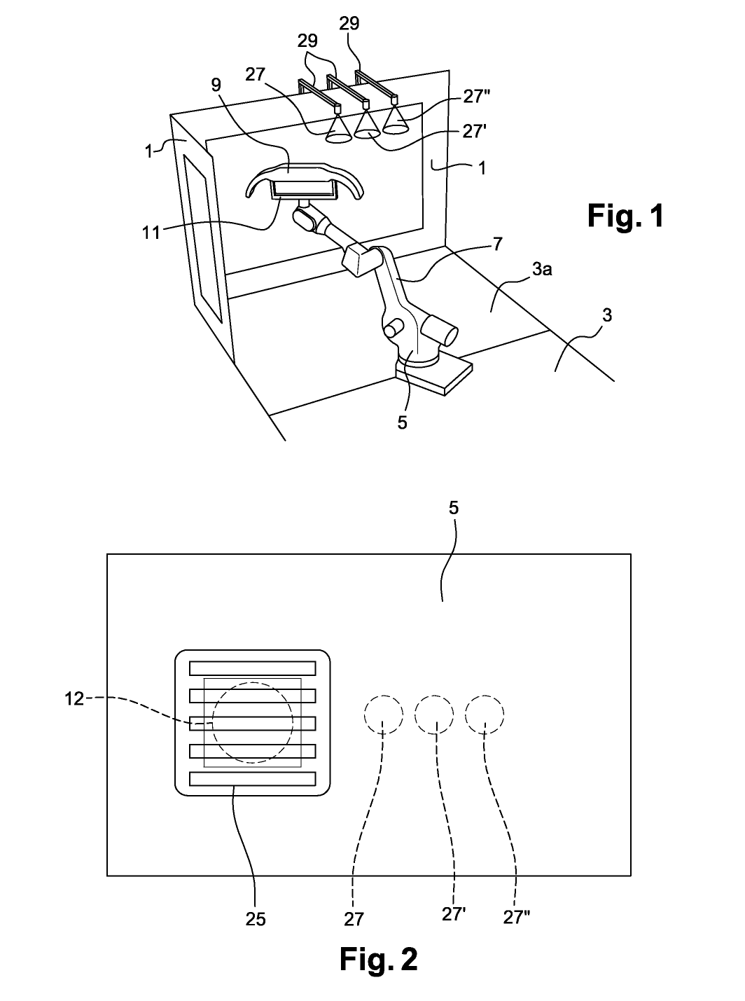

FIG. 1 shows a paint booth having partitions 1, a ceiling (not shown), and a floor 3, with a gridded portion 3a corresponding to air suction.

The floor 3 carries a handler robot 5 having a movable arm 7 with six degrees of freedom. Such a robot is widespread in the automobile industry and is not described herein. By way of example, the P250 model from the supplier Fanuk is suitable for performing the invention. The robot carries a part of large dimensions, constituted in this example by a bumper skin 9.

The end of the arm 7 carries a “universal” gripper 11 that is referred to as “universal” because it can be used without any specific adjustment with a plurality of different parts during a single production campaign. Thus, bumper skins of two or three different models that are being produced at the same time can all be handled by the robot without any need to adjust the gripper between two parts. It is necessary to adjust the gripper only to prepare it for handling other parts in another common production campaign.

Because of its universal gripper 11, the movable arm 7 is capable of presenting the bumper skin 9 before each of three applicators 27, 27′, 27″ that are spaced apart from the ceiling of the booth and that are fed respectively with primer, base, and varnish by pipes 29. These applicators 27, 27′, 27″ are stationary and positioned in such a manner that a part can be oriented and placed with its portion for painting so that it faces each of them.

The streams of paint component droplets sprayed by each applicator 27, 27′, 27″ are delivered by the applicator in a vertically downward direction onto the bumper skin. The stream is thus oriented in the same direction as the stream of air entering into the grid 3a and in the same direction as gravity. It therefore benefits from optimum conditions for being applied uniformly over the entire surface of the bumper skin that is to be painted.

The surface for painting is the outside face of the bumper skin 9. It is covered in a uniform layer of primer, of base, and then of varnish by virtue of the fact that the arm 7 moves the bumper skin 9 so as to present each portion of said surface for painting at an appropriate distance and for an appropriate exposure time.

The first applicator 27 is an air sprayer, e.g. of the AGMD type from ITW, thus making it possible to spray a primer of the two-component conductive primer type for use with polypropylene. The second applicator 27′ and the third applicator 27″ are rotating bowl sprayers, e.g. of type RB1000 from ABB or of type PPH607 from Sames, all well known in the field of painting. They make it possible respectively to spray a single component type base of the polyester type and a two-component type varnish that is acrylic-based.

As can be seen in FIG. 2, which shows the ceiling 5 of the booth, a grid 25 is arranged close to the applicators (their locations being drawn in dashed lines) so as to pass air coming from a blower 12, which air is dry and hot, being at about 20% relative humidity and at a temperature of about 45° C., thereby serving to accelerate the flash-off of the parts after each of the three components have been applied.

The time during which the robot 5 presents a part in front of the blower 12 is 60 seconds.

Because the part is held by the robot 5 during blowing, it may be swiveled and moved in front of the grid 25 so as to put all of the painted surface of the part 9 into contact with the hot air, thereby optimizing the effect of the hot air on evaporating solvent (or water). In other words, the robot can itself also contribute to reducing flash-off time by increasing the efficiency of the flash-off accelerator.

Because flash-off time is optimized, the method of the invention consisting in not putting down the part during flash-off achieves significant advantages.

Another advantage of the invention is the compactness of the painting installation, which amounts to no more than the booth on its own.

Naturally, the implementation described above does not present any limiting character and may receive any desirable modification without thereby going beyond the ambit defined by the accompanying claims.

What is claimed is:

1. A method of painting a motor vehicle bodywork part, the method comprising the steps consisting in applying a first component on the part and in allowing said first component to tension on said part during a so-called “flash-off” stage, wherein during at least the flash-off stage, the part is moved by a handler robot in front of flash-off acceleration means.

2. A method according to claim 1, wherein a second component is applied on the part after the flash-off step.

3. A method according to claim 1, wherein the flash-off acceleration means comprise an air blower that blows air onto the part at a speed greater than the speed of the air around the part during the application step.

4. A method according to claim 1, wherein the flash-off acceleration means comprise a blower for blowing air that is hot and/or dry.

5. A method according to claim 1, wherein the flash-off acceleration means comprise a source of ultraviolet or infrared radiation.

6. A method according to claim 1, wherein the part is moved by the robot during the operation of the flash-off acceleration means so as to expose the entire painted surface of the part to said flash-off acceleration means.

7. A method according to claim 1, wherein the flash-off acceleration means comprise a part support for interposing between an arm of the handler robot and the part, said support presenting surfaces that contact with non-painted portions of the part, these contact surfaces being provided with heater means.

8. A method according to claim 1, wherein the part is moved by the handler robot in front of an applicator for applying a paint component during at least one of the application steps.

9. A method according to claim 1, wherein the applicator is stationary.

10. A painting installation, comprising at least one applicator for applying a paint component on a part, a handler robot, and flash-off acceleration means for accelerating the flash-off of the part and arranged in such a manner that the part can enter into the field of action of the acceleration means while being carried by the handler robot.

11. An installation according to claim 9, wherein the acceleration means are put into operation only while the arm of the handler robot is presenting the part in the field of action of said acceleration means.

12. A painting installation according to claim 10, comprising a booth and in which the handler robot is present in the booth, where it is used for presenting the part for painting in front of a paint applicator, prior to presenting the part in front of the flash-off acceleration means.

13. A painting installation according to claim 10, wherein the applicator is stationary.
